(19) United States
(12) Patent Application Publication
(10) Pub. No.: US 2009/0081617 A1
(43) Pub. Date: Mar. 26, 2009

(54) Display interface target positioning tool

(75) Inventors: Glen R. Freeman, Trophy Club, TX (US); Gary L. Severance, Dallas, TX (US)

Correspondence Address: LAW OFFICE OF DAVID H. JUDSON, 15950 DALLAS PARKWAY, SUITE 225, DALLAS, TX, 75248, US

(73) Assignee: D4D TECHNOLOGIES, LLC, Richardson, TX (US)

(21) Appl. No.: 12/234,622

(22) Filed: Sep. 20, 2008

Related U.S. Application Data
(60) Provisional application No. 60/974,163, filed on Sep. 21, 2007.

(51) Int. Cl. A61C 13/00; A61C 19/00

(52) U.S. Cl. 433/215; 433/25

(57) ABSTRACT

A target positioning tool for use during the scanning of a dental preparation enables an operator to ensure that the preparation is always properly positioned. In one embodiment, the tool comprises an outer circle and a pair of arcs that are positioned back-to-back. The arcs enable the operator to correctly align the scan to the preparation or with a preparation margin. Preferably, the size of the circle is constant and remains so as the view moves in and out on the display screen.

This application is based on Ser. No. 60/974,163, filed Sep. 21, 2007.

### BACKGROUND OF THE INVENTION

1. Technical Field

The present invention relates to computer-assisted techniques for creating dental restoration models.

2. Brief Description of the Related Art

The art of fabricating custom-fit prosthetics in the dental field is well-known. Prosthetics are replacements for tooth or bone structure. They include restorations, replacements, inlays, onlays, veneers, full and partial crowns, bridges, implants, posts, and the like. Typically, a dentist prepares a tooth for a restoration by removing existing anatomy, which is then lost. The resultant prepared area (a “preparation”) is then digitized (or, in the alternative, a dental impression is taken) for the purpose of constructing a restoration. The restoration itself may be constructed through a variety of techniques including manually constructing the restoration, using automated techniques based on computer algorithms, or a combination of manual and automated techniques.

Computer-assisted techniques have been developed to generate three-dimensional (“3D”) visual images of physical objects, such as a dental preparation. In general, the 3D image may be generated by a computer that processes data representing the surfaces and contours of a physical object. The computer displays the 3D image on a screen or a computer monitor. The computer typically includes a graphical user interface (GUI). Data is generated by optically scanning the physical object and detecting or capturing the light reflected off of the object. Based on processing techniques, the shape, surfaces and/or contours of the object may be modeled by the computer.

During the process of creating a tooth restoration model, one or more user interface tools may be provided to facilitate the design process. One known display technique uses a computer monitor that, under software control, displays a 3-dimensional representation of a tooth model.

### BRIEF SUMMARY

A target positioning tool for use during the scanning of a dental preparation enables an operator to ensure that the preparation is always properly positioned. In one embodiment, the tool comprises an outer circle and a pair of arcs that are positioned back-to-back. The arcs enable the operator to correctly align the scan to the preparation or with a preparation margin. Preferably, the size of the circle is constant and remains so as the view moves in and out on the display screen.

In a particular embodiment, a display method is implemented in a computer for use to facilitate manufacture of a dental preparation. The method begins by displaying a target positioning tool on a visual display. The tool consists essentially of an outer circle and a pair of arcs that are positioned back-to-back within the outer circle. Thereafter, an image of a dental preparation is displayed in juxtaposition to the target positioning tool. The operator uses the tool to ensure that the image is properly positioned. The dental preparation is then scanned.

Other features and advantages of the invention will be apparent to one with skill in the art upon examination of the following figures and detailed description. It is intended that all such additional features and advantages be included within this description, be within the scope of the invention, and be protected by the claims.

### BRIEF DESCRIPTION OF THE DRAWINGS

The subject matter herein may be better understood with reference to the following drawings and its accompanying description. Unless otherwise stated, the components in the figures are not necessarily to scale, emphasis instead being placed upon illustrating the principles of the invention. Moreover, in the figures, like referenced numerals designate corresponding parts throughout the different views.

FIG. 1 illustrates a workstation display interface;

FIG. 2 illustrates a target positioning tool for use on the display interface according to the subject matter herein;

FIG. 3 illustrates the target positioning tool of FIG. 2 in association with a user interface display panel prior to initiating an intra-oral scan;

FIG. 4 illustrates how the target positioning tool enables an operator to ensure that the dental preparation is centered and fills the scan;

FIG. 5 illustrates how the target positioning tool enables the operator to correctly align the scan with a preparation margin and proximal walls of neighboring teeth when scanning on either side of the preparation;

FIG. 6 illustrates a computer system in which the display method herein may be implemented;

FIG. 7 illustrates the use of the target positioning tool for a set of preparation scans.

### DETAILED DESCRIPTION

The subject matter of this disclosure is implemented in a system that is used to design restorative models for permanent placement in a patient's mouth.

In particular, the subject matter relates to a target positioning tool that provides a display method, preferably implemented in a computer, such as a workstation. For illustrated purposes, the workstation is a single machine, but this is not a limitation. More generally, the method is implemented using one or more computing-related entities (systems, machines, processes, programs, libraries, functions, code, or the like) that facilitate or provide the functionality. A representative machine is a computer running commodity hardware, an operating system, an application runtime environment, and a set of applications or processes (e.g., linkable libraries, native code, or the like, depending on platform), that provide the functionality of a given system or subsystem.

In a representative embodiment, a computer workstation in which the target positioning tool is implemented comprises hardware, suitable storage and memory for storing an operating system, one or more software applications and data, conventional input and output devices (a display, a keyboard, a point-and-click device, and the like), other devices to provide network connectivity, and the like. An intra-oral digitizer wand is associated with the workstation to obtain optical scans from a patient's anatomy. A representative digitizer system of this type is described in commonly-owned U.S. Pat. No. 7,184,150, the disclosure of which is incorporated herein by reference. The digitizer scans the restoration site with a scanning laser system and delivers live images to a monitor on the workstation. A milling apparatus is associated with the workstation to mill a dental blank in accordance with a tooth restoration model created by the workstation.

In a typical use scenario, a patient is seated adjacent the workstation. A dentist creates a preparation (“prep”) surface on the tooth that is to receive a restoration. The dentist then scans the prep surface with the intra-oral digitizer. The dentist then proceeds to design the restoration. This comprises the following representative steps. The dentist first defines the “margin” of the prep surface, i.e., the area where the new restoration model will propagate from an outermost edge of the existing tooth structure. The dentist then defines the anatomy of the new restoration model to be used. During the design process, the dentist may be required to adjust the anatomy of the new restoration model. Once the design is accomplished, the dentist then transfers this new restoration model design to the associated milling apparatus. Then, the dentist (or other operator) interacts with the milling apparatus, e.g., to choose a restoration to be milled. After the milling apparatus creates the appropriate restoration, the restoration is retrieved from the milling apparatus and then treated (e.g., stained and glazed) as necessary. The dentist then places the restoration on (on in) the prep tooth, using an appropriate bonding method. The procedure is then complete.

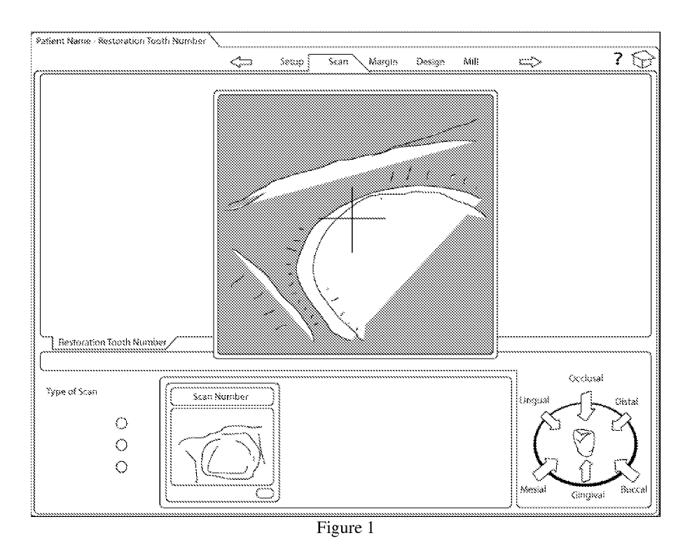

The computer workstation typically includes a display interface that is used during the above-described processing steps. Generally, the display interface comprises an ordered set of display tabs and associated display panels that facilitate the various functions including adding a patient or patient setup, scanning, defining a margin, designing the restoration, and milling. Thus, e.g., during the scan operation, the digitizer scans the restoration site with a scanning laser system and delivers live images to the monitor on the workstation. The images are then rendered in the Scan display panel such as illustrated in FIG. 1.

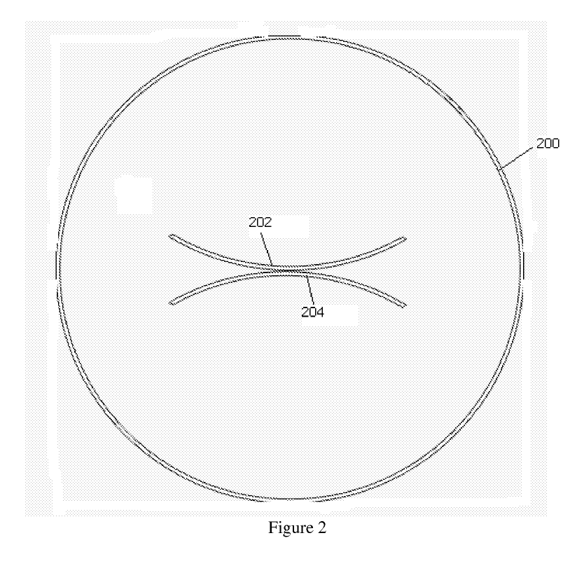

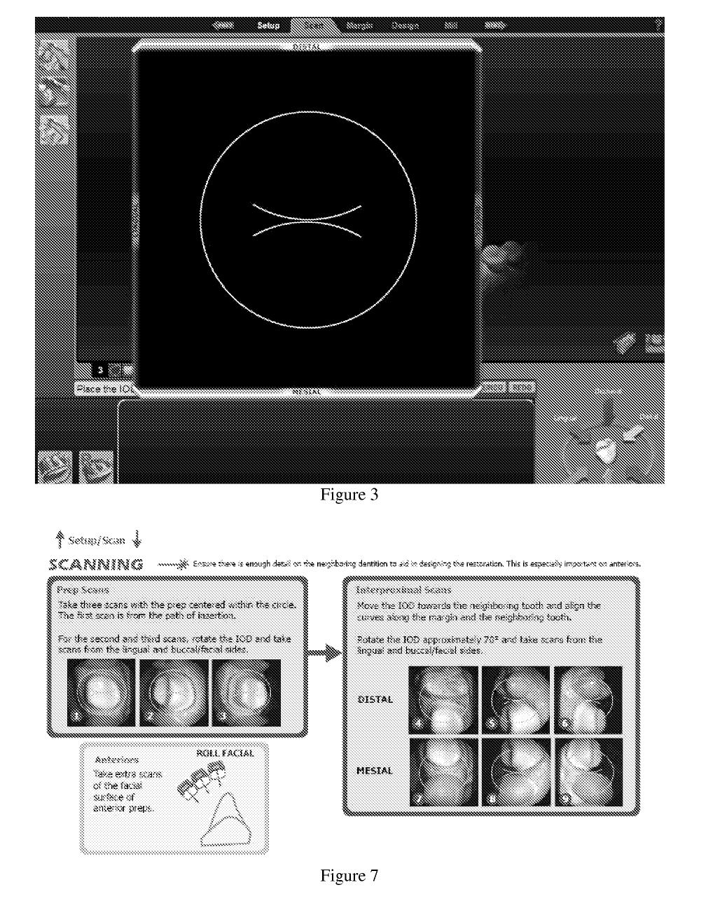

The subject matter herein is a target positioning tool for use during the scanning process. FIG. 2 illustrates a preferred embodiment of the target, which generally comprises an outer circle 200 and a pair of arcs 202 and 204 that are positioned back-to-back, substantially as shown. Modest variations to the target geometry (e.g., an outer set of arcs that are not necessarily closed, a small offset between the two back-to-back arcs, an arc that is not continuous, or the like) are within the scope of this disclosure. The target may include additional lines, graphic elements, or the like. FIG. 3 illustrates the target positioning tool in association with the user interface (UI) display panel prior to initiating a scan.

The circle 200 enables the operator to ensure that the prep is always in the center of the scan and fills the scan, such as shown in FIG. 4. The arcs 202 and 204 are designed to enable the operator to correctly align the scan with the prep margin and proximal walls of the neighboring teeth when scanning on either side of the preparation, such as shown in FIG. 5. Preferably, the size of the circle is constant and remains so even as the view moves in and out. Thus, the circle's diameter (as displayed) is chosen to ensure that, when the tooth is framed within the circle, standoff (z dimension) is correct. Software routines within the workstation re-size the target as necessary. A mechanical standoff tool may be used as an aid in positioning prior to and/or during the actual scan.

FIG. 7 illustrates the use of the target positioning tool for a set of preparation scans with the preparation centered within the circle. The first scan (on the left-side) is from a path of insertion; the second and third scans (also on the left-side) are obtained by rotating the intra-oral device and taking scans from the respective lingual and buccal/facial sides. The right-side of FIG. 7 illustrates a set of inter-proximal scans showing how the target is used to facilitate the alignment.

Preferably, as noted above, the display interface target positioning tool is generated in software (e.g., a set of computer program instructions) executable in at least one processor. A representative implementation is computer program product comprising a tangible medium on which given computer code is written, stored or otherwise embedded.

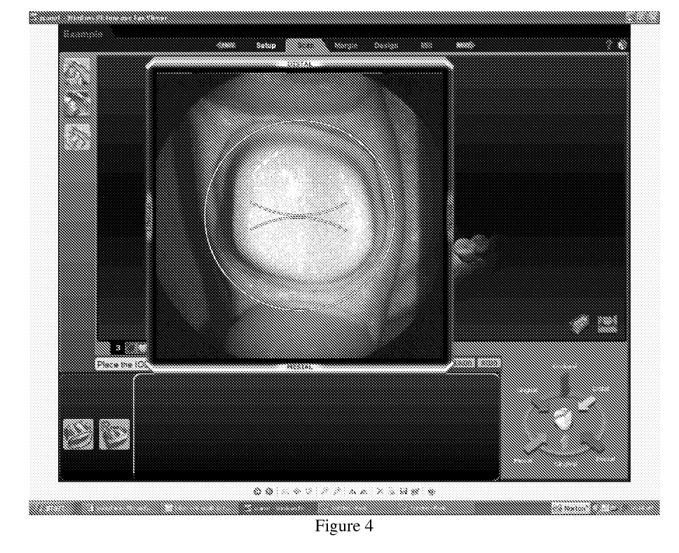

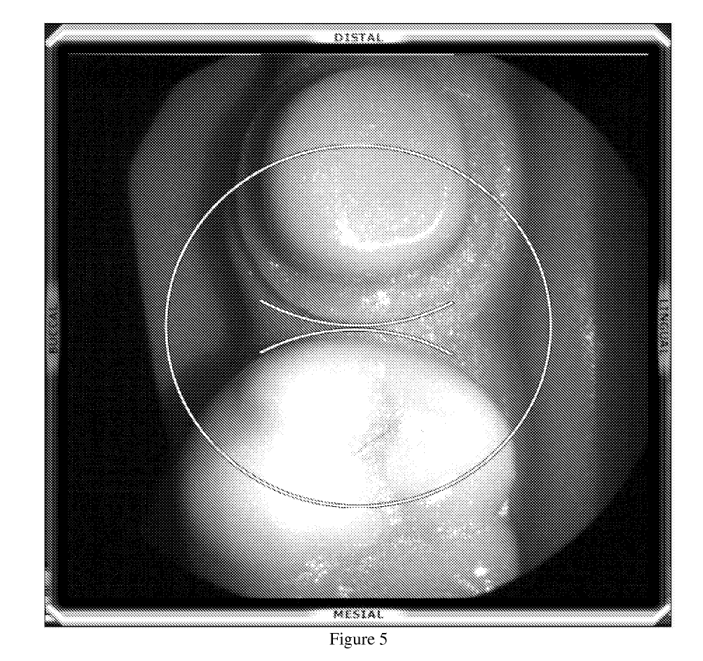

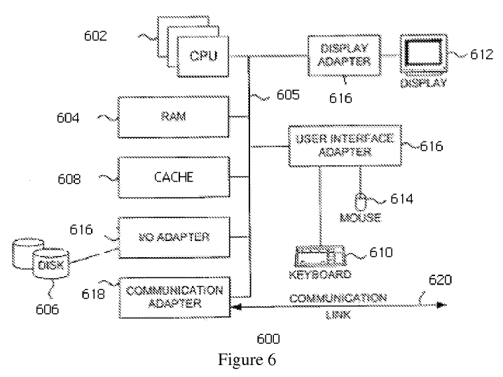

FIG. 6 illustrates a representative data processing system 600 for use in processing the video data in the above-described manner and integrating the resulting 3D restoration model into the virtual preparation model. A data processing system 600 suitable for storing and/or executing program code will include at least one processor 602 coupled directly or indirectly to memory elements through a system bus 605. The memory elements can include local memory 604 employed during actual execution of the program code, bulk storage 606, and cache memories 608 that provide temporary storage of at least some program code to reduce the number of times code must be retrieved from bulk storage during execution. Input/output or I/O devices (including but not limited to keyboards 610, displays 612, pointing devices 614, etc.) can be coupled to the system either directly or through intervening I/O controllers 616. Network adapters 618 may also be coupled to the system to enable the data processing system to become coupled to other data processing systems or devices through intervening private or public networks 620.

While certain aspects or features of the disclosed subject matter have been described in the context of a computer-based method or process, this is not a limitation of the invention. Moreover, such computer-based methods may be implemented in an apparatus or system for performing the described operations, or as an adjunct to other dental restoration equipment, devices or systems. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including optical disks, CD-ROMs, and magnetic-optical disks, read-only memories (ROMs), random access memories (RAMs), magnetic or optical cards, or any type of media suitable for storing electronic instructions, and each coupled to a computer system bus. The described functionality may also be implemented in firmware, in an ASIC, or in any other known or developed processor-controlled device.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic. Further, while given components of the system have been described separately, one of ordinary skill will appreciate that some of the functions may be combined or shared in given systems, machines, devices, processes, instructions, program sequences, code portions, and the like.

Having now described our invention, what we claim is as follows:

1. A display method, implemented in a computer, for use to facilitate manufacture of a dental preparation, comprising:
displaying a target positioning tool consisting essentially of an outer circle and a pair of arcs that are positioned back-to-back within the outer circle;
juxtaposing an image of a dental preparation in a predetermined position with respect to the target positioning tool; and
scanning the dental preparation.

2. The display method as described in claim 1 wherein the predetermined position aligns the dental preparation so that the dental preparation is centered within the outer circle.

3. The display method as described in claim 2 further including maintaining alignment of the dental preparation centered within the outer circle as a z-dimension is adjusted.

4. The display method as described in claim 2 wherein the predetermined position aligns a margin of the dental preparation so that at least one of the pair of arcs is associated with the margin.

5. A computer for use to facilitate manufacture of a dental preparation, comprising:
a display monitor; and
software executable by a processor to: (a) display a target positioning tool consisting essentially of an outer circle and a pair of arcs that are positioned back-to-back within the outer circle, and (b) juxtaposing an image of a dental preparation in a predetermined position with respect to the target positioning tool.
